(19) United States
(12) Patent Application Publication
(10) Pub. No.: US 2026/0278754 A1
(43) Pub. Date: Sep. 17, 2026

(54) ELECTRONIC DEVICE FOR GENERATING IMAGE, AND OPERATING METHOD THEREOF

(71) Applicant: SAMSUNG ELECTRONICS CO., LTD., Suwon-si (KR)

(72) Inventors: Chankyoo MOON, Suwon-si (KR); Bosung KIM, Suwon-si (KR); Jihyun KIM, Suwon-si (KR); Sungkweon PARK, Suwon-si (KR); Hyunseok LEE, Suwon-si (KR)

(21) Appl. No.: 19/640,797

(22) Filed: Apr. 7, 2026

Related U.S. Application Data
(63) Continuation of application No. PCT/KR2024/016179, filed on Oct. 23, 2024.

(30) Foreign Application Priority Data
Oct. 31, 2023 (KR) 10-2023-0146920
Dec. 20, 2023 (KR) 10-2023-0187384

(51) Int. Cl. G06T 5/77; G06T 5/50; G06T 5/60; G06T 11/60; G06V 20/30; G06V 40/10

(52) U.S. Cl. CPC G06T 5/77; G06T 5/50; G06T 5/60; G06T 11/60; G06V 20/30; G06V 40/10; G06T 2207/20081; G06T 2207/30196

(57) ABSTRACT

An electronic device for generating images includes a processor and a memory for storing instructions that cause the electronic device to, in response to a first command to edit a first image, identifies a second image that is captured within a capture threshold of an acquisition time of the first image or is related to a subject of the first image. In some embodiments, the electronic device obtains, from the second image, feature information for generating an image corresponding to a first portion deleted inside the first image or a second portion to be extended outside the first image. The electronic device performs a painting operation to generate the image corresponding to the first portion or the second portion of the first image. The electronic device generates a third image that includes the first image and the image corresponding to the first portion or the second portion.

### CROSS-REFERENCE TO RELATED APPLICATIONS

This application is a continuation application under, 35 U.S.C. § 111(a), of International Patent Application No. PCT/KR2024/016179, filed on Oct. 23, 2024, which claims priority to Korean Patent Application No. 10-2023-0146920, filed on Oct. 30, 2023, and Korean Patent Application No. 10-2023-0187384, filed on Dec. 20, 2023, the content of which in their entirety is herein incorporated by reference.

### BACKGROUND

### 1. Field

The disclosure relates to an electronic device for generating an image and an operation method thereof.

### 2. Description of Related Art

As a result of the rapid development of information and communication technologies, semiconductor technologies, and the like, the distribution and use of various electronic devices are rapidly increasing. Electronic devices are being developed to enable users to carry and communicate using them. An electronic device may refer to a device that performs a specific function according to a built-in program, such as a mobile communication terminal, a tablet PC, a video/audio device, a desktop/laptop computer, or a vehicle navigation system.

Recently, users have shown great interest in obtaining high-quality images provided by advanced camera equipment, not merely capturing and obtaining images using electronic devices. Electronic devices provide a function of editing images. An electronic device may provide an environment in which a user is capable of editing an image stored in the electronic device, by using an image editing application.

### SUMMARY

According to an embodiment, an electronic device includes at least one processor and memory storing instructions. According to an embodiment, the instructions, when executed by the at least one processor collectively or individually, cause the electronic device to, in response to a first command to edit a first image stored in the memory, identify a second image that is captured within a capture threshold of an acquisition time of the first image stored in the memory or is related to a subject of the first image. According to an embodiment, the instructions, when executed by the at least one processor collectively or individually, cause the electronic device to obtain, from the second image, feature information for generating an image corresponding to a first portion deleted from the first image inside the first image or a second portion to be expanded from the first image outside the first image. According to an embodiment, the instructions, when executed by the at least one processor collectively or individually, cause the electronic device to perform, using the first image and the feature information, a painting operation to generate the image corresponding to the first portion or the second portion of the first image. According to an embodiment, the instructions, when executed by the at least one processor collectively or individually, cause the electronic device to generate, based on the painting operation, a third image that includes the first image and the image corresponding to the first portion or the second portion.

According to an embodiment, an operation method of an electronic device includes, in response to a first command to edit a first image stored in the electronic device, identifying a second image captured within a capture threshold of an acquisition time of the first image stored in the memory or is related to a subject of the first image. According to an embodiment, the operation method of the electronic device includes obtaining, from the second image, feature information for generating an image corresponding to a first portion deleted from the first image inside the first image or a second portion to be expanded from the first image outside the first image. According to an embodiment, the operation method of the electronic device includes performing, using the first image and the feature information, a painting operation to generate the image corresponding to the first portion or the second portion of the first image. According to an embodiment, the operation method of the electronic device includes generating, based on the painting operation, a third image that includes the first image and the image corresponding to the first portion or the second portion.

According to an embodiment, a non-transitory computer-readable recording medium stores instructions. According to an embodiment, the instructions, when executed by the at least one processor collectively or individually, cause the electronic device to, in response to a first command to edit a first image stored in the electronic device, identify a second image captured within a capture threshold of an acquisition time of the first image stored in the electronic device or is related to a subject of the first image. According to an embodiment, the instructions, when executed by the at least one processor collectively or individually, cause the electronic device to obtain, from the second image, feature information for generating an image corresponding to a first portion deleted from the first image inside the first image or a second portion to be expanded from the first image outside the first image. According to an embodiment, the instructions, when executed by the at least one processor collectively or individually, cause the electronic device to perform, using the first image and the feature information, a painting operation to generate the image corresponding to the first portion or the second portion of the first image. According to an embodiment, the instructions, when executed by the at least one processor collectively or individually, cause the electronic device to generate a third image that includes the first image and the image corresponding to the first portion or the second portion generated based on the painting operation.

### BRIEF DESCRIPTION OF DRAWINGS

FIG. 1 is a block diagram illustrating an electronic device in a network environment according to an embodiment.

FIG. 2A is a diagram illustrating a method of obtaining an image by performing an in-painting operation on a first image according to an embodiment.

FIG. 2B is a diagram illustrating a method of obtaining an image by performing an out-painting operation on a first image according to an embodiment.

FIG. 3 is a diagram illustrating a method of obtaining an image by performing an out-painting operation on a first image according to a comparative example.

FIG. 4 is a block diagram illustrating a configuration of an electronic device according to an embodiment.

FIG. 5 is a block diagram illustrating an AI model including an image generation model and a feature extraction model according to an embodiment.

FIG. 6 is a flowchart illustrating a method in which an electronic device performs a painting operation on a first image, according to an embodiment.

FIG. 7 is a flowchart illustrating a method in which an electronic device performs a painting operation on a first image, according to an embodiment.

FIG. 8 is a diagram illustrating a method in which an electronic device performs a painting operation on a first image, according to an embodiment.

FIG. 9 is a diagram illustrating a method in which an electronic device extracts text from feature information, according to an embodiment.

FIG. 10 is a diagram illustrating a method in which an electronic device obtains a text prompt, according to an embodiment.

### DETAILED DESCRIPTION

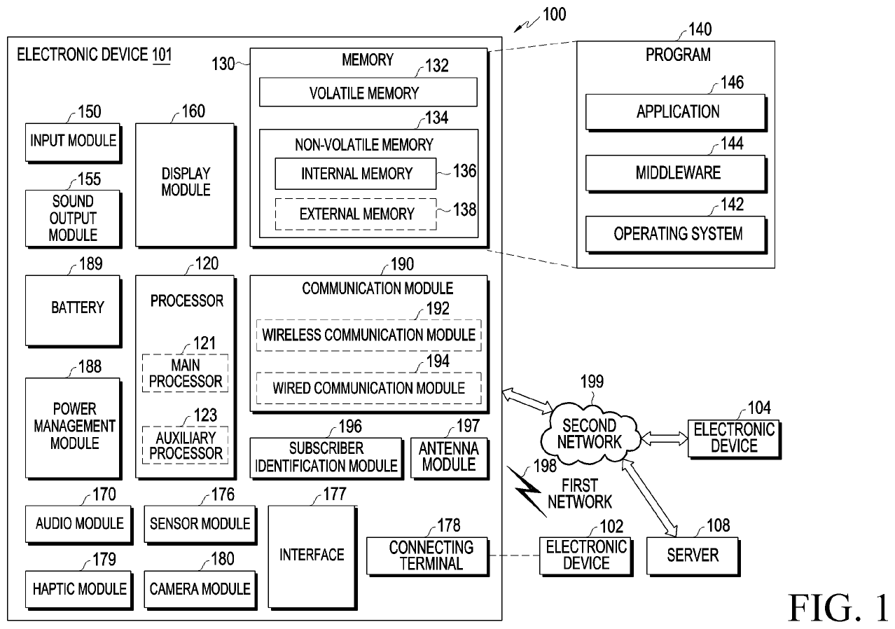

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mm Wave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mm Wave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IOT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

In the following detailed description, configurations that may be readily understood through previous embodiments will be given the same reference numerals or omitted, and detailed descriptions thereof may also be omitted. An electronic device according to an embodiment disclosed herein may be implemented by selectively combining configurations of different embodiments, and a configuration of one embodiment may be replaced by a configuration of another embodiment. It is noted that the disclosure is not limited to a particular drawing or embodiment.

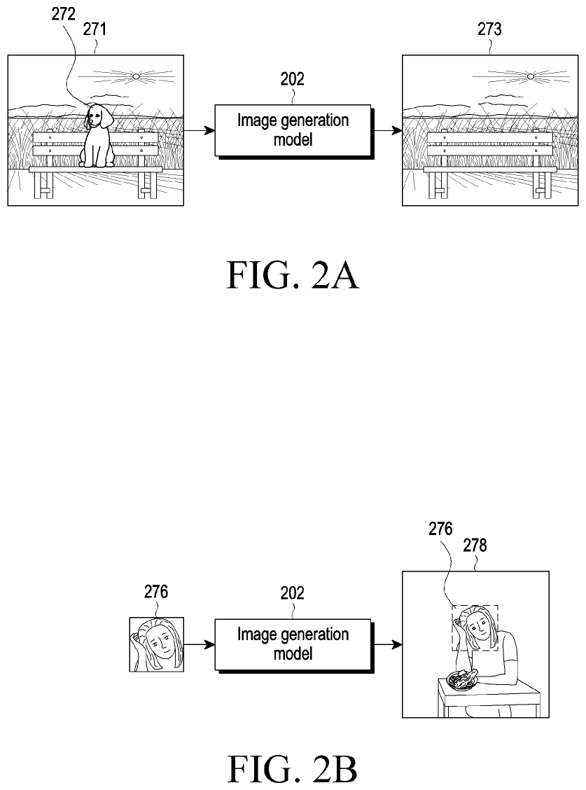

FIG. 2A is a diagram illustrating a method of obtaining an image by performing an in-painting operation on a first image according to an embodiment. FIG. 2B is a diagram illustrating a method of obtaining an image by performing an out-painting operation on a first image according to an embodiment.

Referring to FIGS. 2A and 2B, according to an embodiment, an electronic device (e.g., the electronic device 101 of FIG. 1 or an electronic device 201 of FIG. 4) stores an image generation model 202. The image generation model 202 includes an artificial intelligence (AI) model. For example, the artificial intelligence model includes a generative artificial intelligence model. For example, the generative artificial intelligence model generates new content similar to existing content, such as text, audio, and/or images, by using the existing content. For example, the generative artificial intelligence model learns patterns of contents and generates new content as a result of inference. For example, the image generation model 202 generates (or obtains or outputs) a second image 273 or 278 by performing at least one of an in-painting operation or an out-painting operation on a first image 271 or 276.

According to an embodiment, the in-painting operation refers to an operation (or function) of generating (or coloring) a deleted portion in an image to match the surrounding area by using an AI model. Alternatively, the in-painting operation refers to an operation of generating (or coloring) a portion hidden by an object in an image to match the surrounding area by using an AI model.

According to an embodiment, the out-painting operation refers to an operation (or function) of generating (or coloring) a portion such that the portion matches an existing image while expanding an outer region of an image by using an AI model.

Referring to FIG. 2A, according to an embodiment, the first image 271 includes an image in which a portion corresponding to an object 272 is deleted (or removed). For example, the first image 271 is an image stored in the electronic device 101 or 201.

According to an embodiment, the image generation model 202 performs an in-painting operation on the first image 271 to generate (e.g., color) an image of the corresponding portion 272 such that the portion 272 corresponding to the object matches the surrounding background (or surrounding objects). For example, the image generation model 202 generates an image (e.g., pixel values of the corresponding portion 272) related to the deleted portion 272 inside the first image. The image generation model 202 generates or outputs a second image 273 including the image generated by the in-painting operation.

According to an embodiment, the first image 271 includes an image including the object 272. The image generation model 202 performs an in-painting operation on the first image 271 to generate (e.g., color) an image of the corresponding portion 272 such that the portion 272 hidden by an object matches the surrounding background (or surrounding objects). For example, the image generation model 202 generates an image (e.g., pixel values of the corresponding portion 272) for the portion 272 hidden by the object in the first image 271. The image generation model 202 generates, produces, or outputs the second image 273 that includes the image generated by the in-painting operation.

Referring to FIG. 2B, according to an embodiment, a first image 276 includes an image including a portion of an object (e.g., a human subject). For example, the first image 276 is an image stored in the electronic device 101 or 201.

According to an embodiment, the image generation model 202 performs an out-painting operation on the first image 276 and expands the first image 276 to generate the second image 278, such that a remaining portion of the object of the second image 278 and/or the background of the second image 278 matches the first image 276. For example, the image generation model 202 expands the first image up to a designated range (e.g., a designated range based on a display screen size or a size designated by a user). For example, the image generation model 202 expands the first image 276 based on an expanded display screen size (or a display area of the expanded display) for an electronic device, such as a roller display or a foldable display. For example, when the object of the first image 276 does not represent the entire object, the image generation model 202 generates the remaining portion of the object. The image generation model 202 expands the background of the first image 276 to a designated range. In this example, the image generation model 202 generates (e.g., color) an image of a portion to be expanded outside the first image 276. The image generation model 202 generates, produces, or outputs a second image 278 that includes the existing first image 276 and the image newly generated by the out-painting operation.

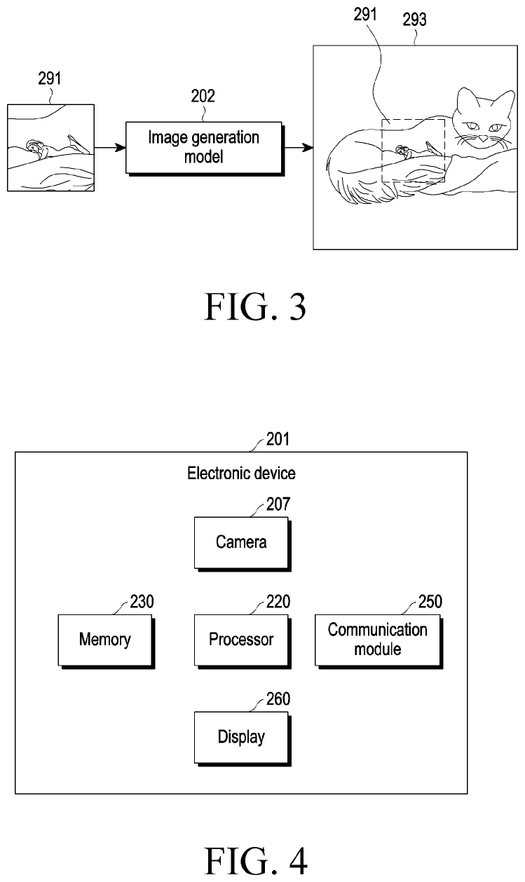

FIG. 3 is a diagram illustrating a method of obtaining an image by performing an out-painting operation on a first image according to an embodiment.

Referring to FIG. 3, according to a comparative example, the image generation model 202 generates a second image 293 based on a first image 291. In this example, the image generation model 202 generates a person or a background that does not match the context of the first image 291 because the image generation model 202 generates the second image 293 based on the first image 291 provided or input to the image generation model 202. For example, the image generation model 202 may recognize a “furry cushion” on which a “person” is lying on in the first image 291 as “cat fur,” and may generate the second image 293 that includes a “cat.” That is, the second image 293 includes an image that does not match the context of the existing first image 291, which is a “person” lying on a “cat.”

According to an embodiment of the disclosure, when performing a painting operation (e.g., an in-painting operation or an out-painting operation) on the first image 291 by using the image generation model 202, information (e.g., feature information associated with another image) associated with another image related to the first image may be provided to or input to the image generation model 202. The image generation model 202 performs a painting operation (e.g., an in-painting operation or an out-painting operation) on the first image 291 in consideration of information associated with the other image related to the first image, as well as, information associated with the first image. Through this, the image generation model 202 according to an embodiment generates (or outputs) an image corresponding to the context of the existing first image 291. In addition, the electronic device 101 or 201 according to an embodiment may reduce a sense of incongruity of an image generated by using the image generation model 202 and may generate an image based on reality.

FIG. 4 is a block diagram illustrating a configuration of an electronic device according to an embodiment.

FIG. 4 illustrates the electronic device 201 (e.g., the electronic device 101 of FIG. 1) according to an embodiment.

According to an embodiment, the electronic device 201 includes a camera 207, a processor 220, memory 230, a communication module 250, and a display 260. For example, the electronic device 201 is implemented in the same or similar manner as the electronic device 101 of FIG. 1.

According to an embodiment, the electronic device 201 generates an image for a first portion deleted inside a first image or a second portion to be expanded outside the first image, by using the image generation model 202. The electronic device 201 obtains or outputs an image including the existing first image and the newly generated image of the first or second portions, by using the image generation model 202. For example, the image generation model 202 includes a pre-trained AI model and stores the same in the memory 230.

According to an embodiment, the processor 220 controls the overall operation of the electronic device 201. For example, the processor 220 is implemented in the same or similar manner as the processor 120 of FIG. 1.

According to an embodiment, the processor 220 identifies a first command to edit a first image stored in the memory 230. For example, when a specified user input (e.g., a touch input, a gesture input, or a voice input) is identified, the processor 220 identifies the first command to edit the first image. For example, the operation of editing the first image includes an operation of performing a painting operation (e.g., an in-painting operation and/or an out-painting operation) on the first image. For example, the first image may include an image captured using the camera 207. Alternatively, the first image may include an image received or obtained from an external electronic device.

According to an embodiment, in response to the first command, the processor 220 identifies a second image highly related to the first image among a plurality of images stored in the memory 230. For example, from among the plurality of images stored in the memory 230, the processor 220 determines that at least one image includes a person, an animal, an object, a background, or a place in or of the first image as the second image that is highly related to the first image. For example, the processor 220 identifies the second image that is highly related to the first image by using at least one of a capture time, a place, or scene analysis associated with the images. For example, the processor 220 determines or identifies, as the second image, an image having an acquisition time (e.g., a capture time) similar to that of the first image. The processor 220 may determine or identify, as the second image, an image including a subject (e.g., a person or an animal) that is in or of the first image. Alternatively, the processor 220 may determine or identify, as the second image, an image captured in the same place as that of the first image.

According to an embodiment, the processor 220 determines, as the second image, at least one image including the same person as a person included in the first image, among images obtained on the same day as the first image. According to another embodiment, the processor 220 determines, as at least one second image, at least one image that is captured within a capture threshold. An image that is captured within the capture threshold is an image obtained before or after a specified time (e.g., 30 minutes), such as the acquisition time of the first image, among the plurality of images stored in the memory 230. In some embodiments, the capture threshold of an acquisition time of an image is a period of time that is before and/or after the acquisition time.

According to an embodiment, the processor 220 extracts or obtains feature information from the second image. For example, the feature information obtained from the second image includes information for generating the first portion deleted inside the first image or the second portion to be expanded outside the first image. For example, the feature information includes information associated with at least one of a color, a shape, a form, an object, a background, or a composition of the second image. For example, the feature information may include a text guide, a feature map, or a face feature. For example, the processor 220 may obtain a feature map including values representing features of the second image. For example, the feature map may include information in which a color, a shape, a form, an object, a background, or a composition of the second image is expressed as a specific value (e.g., a vector value). According to an embodiment, the processor 220 may obtain information associated with a text guide and/or a facial feature by using the feature map.

According to an embodiment, the processor 220 performs a painting operation of generating an image corresponding to the first portion or the second portion of the first image by using the first image and the feature information. For example, the processor 220 may perform an in-painting operation of generating the first portion of the first image by using the image generation model 202. In addition, the processor 220 performs an out-painting operation of generating the second portion of the first image by using the image generation model 202. For example, the processor 220 performs a painting operation (e.g., an in-painting operation or an out-painting operation) that generates the image corresponding to the first portion of the second portion of the first image by inputting the first image, the feature information, and a text prompt for commanding a painting operation (e.g., an in-painting operation or an out-painting operation) on the first image to the image generation model 202.

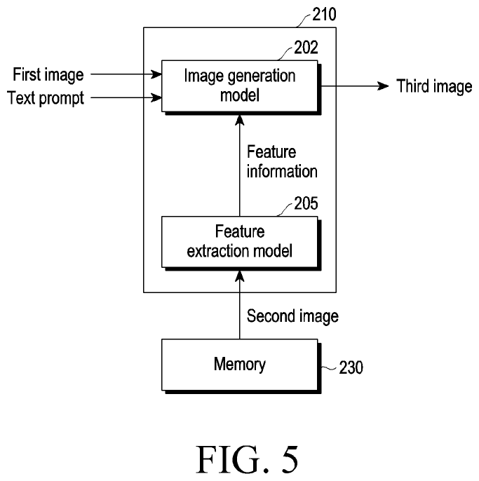

According to an embodiment, the processor 220 obtains a prompt (or prompt data) for generating the image corresponding to the first or second portion of the first image, from the feature information of the second image, by using a feature extraction model (e.g., a feature extraction model 205 of FIG. 5) stored in the memory. For example, the processor 220 may use the feature extraction model (e.g., the feature extraction model 205 of FIG. 5) stored in the memory to obtain a first text for generating the image corresponding to the first or second portion of the first image from the feature information of the second image. For example, the first text may include text (or a text prompt) representing at least one of the color, shape, form, object, background, or composition of the second image for generating the first or second portion of the first image.

According to an embodiment, the processor 220 may generate a text prompt for generating the image corresponding to the first or second portion of the first image, based on the first text. For example, the text prompt (or text instruction) may include a text-type instruction recognizable by the image generation model 202. For example, the text prompt may include an instruction for an artificial intelligence model to perform a painting operation on the first image.

According to an embodiment, the processor 220 generates or obtains a third image that includes the first image and the image corresponding to the first or second portion generated based on the painting operation, as a result of the painting operation. For example, the third image may include an image in which the first portion deleted from or hidden by a specific object in the existing first image is generated (e.g., regenerated, colored, or added) by in-painting the first image. Alternatively, the third image may include an image that further includes an image corresponding to the second portion generated by out-painting the first image in addition to the first image.

The electronic device 201, according to an embodiment, may further provide or input feature information associated with another image related to the first image to the image generation model 202, in addition to providing the first image to the image generation model 202, and may perform a painting operation (e.g., an in-painting operation or an out-painting operation) on the first image. Accordingly, the electronic device 201, according to an embodiment, generates (e.g., obtains or outputs) an image (e.g., the third image) that is in-painted or out-painted to match the context of the existing first image. For example, the electronic device 201 displays the third image on the display 260.

FIG. 5 is a block diagram illustrating an AI model that includes an image generation model and a feature extraction model according to an embodiment.

Referring to FIG. 5, according to an embodiment, the AI model 210 may be stored in the memory 230 (e.g., the memory 230 of FIG. 4) of the electronic device 201 (e.g., the electronic device 201 of FIG. 4). The AI model 210 may be previously trained. For example, the AI model 210 may be trained by the electronic device 201 or by an external electronic device. For example, the AI model 210 may be implemented by software and/or hardware.

According to an embodiment, the AI model 210 may include the image generation model 202 and the feature extraction model 205. The image generation model 202 and the feature extraction model 205 may be implemented as separate AI models. Alternatively, unlike FIG. 5, the image generation model 202 and the feature extraction model 205 may be implemented as a single AI model.

According to an embodiment, the feature extraction model 205 extracts or obtains feature information for generating an image corresponding to a first or second portion of a first image from a second image related to the first image among a plurality of images stored in the memory 230. The feature extraction model 205 provides feature information to the image generation model 202. For example, the feature extraction model 205 obtains, as the feature information, a first text for generating the image corresponding to the first or second portion of the first image. For example, the first text may include text indicating at least one of a color, a shape, a form, an object, a background, or a composition of the second image for generating the first portion or the second portion of the first image.

According to an embodiment, the processor 220 (e.g., the processor 220 of FIG. 4) generates, based on the first text, a text prompt for generating the image corresponding to the first portion or the second portion of the first image. For example, the text prompt (or text instruction) may include a text-type instruction recognizable by the image generation model 202.

According to an embodiment, the image generation model 202 receives an input of the first image, the feature information, and the text prompt, and generates or outputs a third image. According to an embodiment, based on the text prompt, the image generation model 202 may start or execute a painting operation on the first image. In this case, the image generation model 202 generates, based on the feature information, the image corresponding to the first portion or the second portion of the first image. For example, the third image may include an image in which the first portion deleted from or hidden by a specific object in the existing first image is generated (e.g., regenerated, colored, or added) by in-painting the first image. Alternatively, the third image may include an image that further includes an image corresponding to the second portion generated by out-painting the first image in addition to the first image.

Based on the above-described method, the electronic device 201, according to an embodiment, may generate (e.g., obtain or output) an image (e.g., the third image) that is in-painted or out-painted to match the context of the existing first image.

At least a portion of the operations of the electronic device 201 described below may be performed by the processor 220 or the AI model 210. However, for ease of description, it is described that the following operations are performed by the electronic device 201.

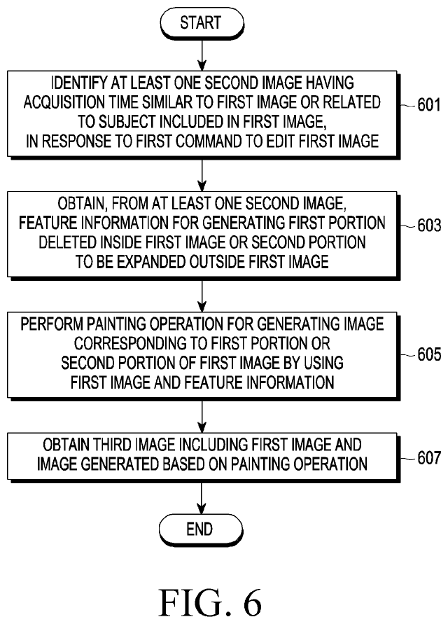

FIG. 6 is a flowchart illustrating a method in which an electronic device performs a painting operation on a first image, according to an embodiment.

Referring to FIG. 6, according to an embodiment, in operation 601, in response to a first command to edit a first image, the electronic device 201 (e.g., the electronic device 201 of FIG. 4) identifies at least one second image that has an acquisition time similar to that of the first image or that is related to a subject (or a background) of the first image. In some embodiments, the processor 220 determines that the second image has an acquisition time similar to the acquisition time of the first image by determining that the second image is captured within a capture threshold of the acquisition time of the first image.

According to an embodiment, in operation 603, the electronic device 201 obtains, from the at least one second image, feature information for generating an image corresponding to a first portion deleted inside the first image or a second portion to be expanded outside the first image.

According to an embodiment, in operation 605, the electronic device 201 performs a painting operation for generating the image corresponding to the first or second portion of the first image by using the first image and the feature information. For example, the electronic device 201 obtains a text prompt (or text instruction) for performing a painting operation on the first image, based on the feature information (e.g., text indicating a feature of the second image). The electronic device 201 provides or inputs the text prompt, the first image, and the feature information to an image generation model (e.g., the image generation model 202 of FIG. 5), which performs a painting operation (e.g., an in-painting operation or an out-painting operation) on the first image. Based on the painting operation, the electronic device 201 generates the image corresponding to the first portion or the second portion.

According to an embodiment, in operation 607, the electronic device 201 obtains or generates a third image including the first image and the image generated based on the painting operation. For example, the image generation model 202 may output the third image as a result of the painting operation on the first image.

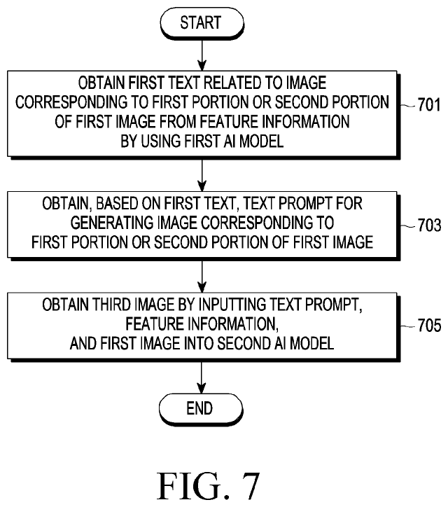

FIG. 7 is a flowchart illustrating a method in which an electronic device performs a painting operation on a first image, according to an embodiment.

Referring to FIG. 7, according to an embodiment, in operation 701, the electronic device 201 obtains a first text related to an image corresponding to a first portion or a second portion of a first image from feature information of a second image by using a first AI model (e.g., the feature extraction model 205 of FIG. 5). For example, the first text may include text indicating information for a painting operation on the first image, among features of the second image.

According to an embodiment, in operation 703, the electronic device 201 obtains, based on the first text, a text prompt for generating the image corresponding to the first or second portion of the first image. For example, the text prompt may include an instruction (or text) that commands a second AI model (e.g., the image generation model 202 of FIG. 5) to perform a painting operation on or using the first image.

According to an embodiment, in operation 705, the electronic device 201 provides or inputs the text prompt, the feature information of the second image, and the first image to the second AI model (e.g., the image generation model 202 of FIG. 5) to obtain or generate a third image. For example, the electronic device 201 provides or inputs the text prompt, the feature information of the second image, and the first image to the second AI model to perform the painting operation (e.g., an in-painting operation or an out-painting operation) on the first image. The electronic device 201 performs the painting operation to generate or obtain the third image.

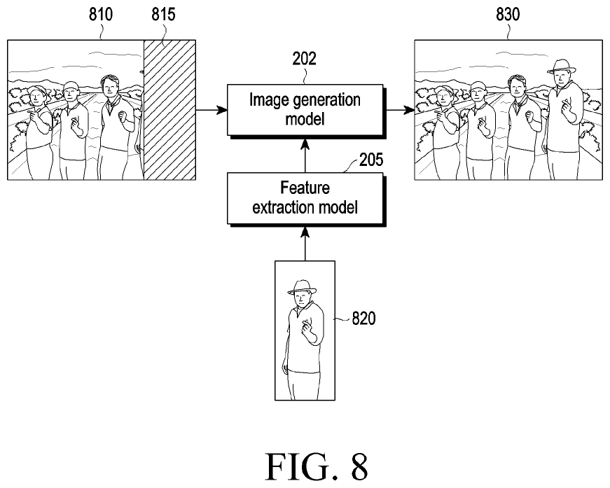

FIG. 8 is a diagram illustrating a method in which an electronic device performs a painting operation on a first image, according to an embodiment.

Referring to FIG. 8, an electronic device (e.g., the electronic device 201 of FIG. 4) according to an embodiment may generate an image corresponding to a first portion 815 deleted inside a first image 810. For example, the electronic device 201 performs an in-painting operation on the first image 810 by using the image generation model 202 to generate the image corresponding to the first portion 815.

According to an embodiment, the image generation model 202 receives an input of feature information of a second image 820 related to the first image 810 in order to generate the image corresponding to the first portion 815. For example, the second image 820 may be an image including the same person as a person included in the first image 810, among images obtained on the same day as the first image 810. For example, the electronic device 201 may analyze a figure, clothing, composition, and/or posture of a person, and identify the second image 820 that includes the same person as the person included in the first image 810.

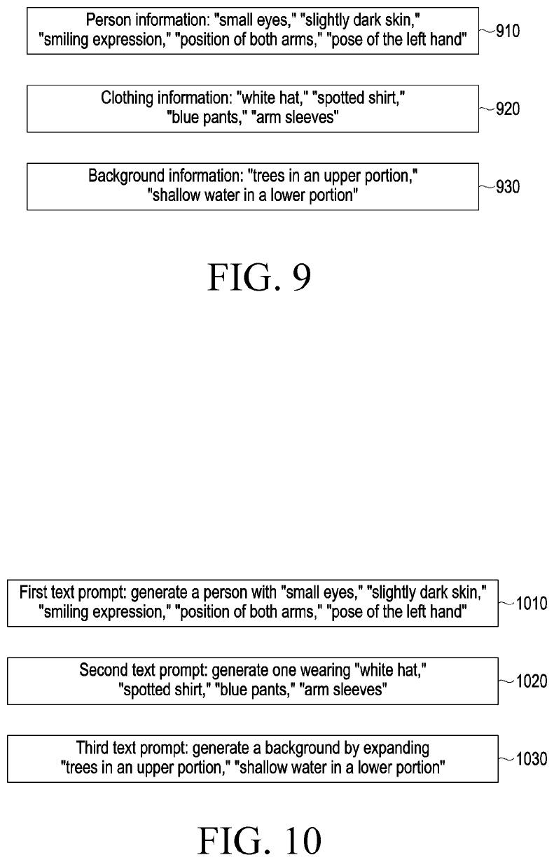

According to an embodiment, the feature extraction model 205 extracts (or obtains) feature information for generating the image corresponding to the first portion 815 of the first image 810 from the second image 820. For example, the feature extraction model 205 may obtain, as the feature information, a first text (e.g., first text 910, a second text 920, and a third text 930 as further discussed in FIG. 9) for generating the image corresponding to the first portion 815 of the first image 810.

According to an embodiment, the electronic device 201 may perform an in-painting operation on the first image 810 by using the first image 810 and the feature information and may generate or obtain a third image 830. For example, the third image 830 may include the first image 810 and an image corresponding to the first portion 815 of the first image 810 generated by the in-painting operation.

Based on the above-described method, the electronic device 201 according to an embodiment may generate (e.g., obtain or output) an in-painted image (e.g., the third image) that matches the context of the existing first image.

An out-painting operation on the first image 810 according to an embodiment of the disclosure may also be performed in the same or similar manner as the in-painting operation described above.

FIG. 9 is a diagram illustrating a method in which an electronic device extracts text from feature information according to an embodiment.

Referring to FIG. 9, an electronic device (e.g., the electronic device 201 of FIG. 4) according to an embodiment obtains feature information of a second image (e.g., the second image 820 of FIG. 8) related to a first image 810, which is to be regenerated, among a plurality of images stored in the electronic device 201. For example, the electronic device 201 obtains texts 910, 920, and 930, which include, describe, or indicate a feature of the second image 820 by using a feature extraction model (e.g., the feature extraction model 205 of FIG. 5). For example, when a specific person is included in the second image 820, the texts 910, 920, and 930 may include person information 910, clothing information 920, and background information 930. For example, the person information 910 may include text (e.g., “small eyes,” “slightly dark skin,” “smiling expression,” “position of both arms,” or “pose of the left hand”) indicating the specific person included in the second image. For example, the clothing information 920 may include text (e.g., “white hat,” “spotted shirt,” “blue pants,” “arm sleeves”) indicating clothing of the specific person included in the second image. For example, the background information 930 may include text (e.g., “trees in an upper portion,” “shallow water in a lower portion”) indicating a background included in the second image.

According to an embodiment, the electronic device 201 may provide at least one of the person information 910, the clothing information 920, and the background information 930 to the image generation model 202 in order to perform a painting operation on the first image.

FIG. 10 is a diagram illustrating a method in which an electronic device obtains a text prompt, according to an embodiment.

Referring to FIG. 10, according to an embodiment, an electronic device (e.g., the electronic device 201 of FIG. 4) obtains a text prompt by using feature information (e.g., the person information 910, clothing information 920, and background information 930 of FIG. 9) of a second image (e.g., the second image 820 of FIG. 8). For example, the text prompt may include a first text prompt 1010, a second text prompt 1020, and a third text prompt 1030.

According to an embodiment, the first text prompt 1010 may be obtained or generated based on the person information 910. The second text prompt 1020 may be obtained or generated based on the clothing information 920. The third text prompt 1030 may be obtained or generated based on the background information 930.

According to an embodiment, the electronic device 201 may provide at least one of the first text prompt 1010, the second text prompt 1020, and the third text prompt 1030 to the image generation model 202 to perform a painting operation on a first image.

Although it is illustrated that three different text prompts 1010, 1020, and 1030 are generated in FIG. 10, this may be merely an example. For example, a text prompt provided to the image generation model 202 may be implemented as a single text prompt. For example, one text prompt may be generated or determined based on the three text prompts 1010, 1020, and 1030.

As described above, the image generation model 202 performs a painting operation (e.g., an in-painting operation or an out-painting operation) on the first image in consideration of not only the first image but also information (e.g., feature information or text indicating a feature) related to another image related to the first image. This enables the image generation model 202, according to an embodiment, to generate (or output) an image that matches the context of the existing first image 291. In addition, the electronic device 101 or 201 according to an embodiment may reduce a sense of incongruity in an image generated by using the image generation model 202 and may generate an image based on reality.

According to an embodiment, an electronic device may include the at least one processor 220 and the memory 230 storing instructions. According to an embodiment, the instructions, when executed by the at least one processor collectively or individually, may cause the electronic device to, in response to a first command to edit a first image stored in the memory, identify a second image that is captured within a capture threshold of an acquisition time of the first image stored in the memory or is related to a subject of the first image. According to an embodiment, the instructions, when executed by the at least one processor collectively or individually, may cause the electronic device to obtain, from the second image, feature information for generating an image corresponding to a first portion deleted inside the first image or a second portion to be expanded outside the first image. According to an embodiment, the instructions, when executed by the at least one processor collectively or individually, may cause the electronic device to perform a painting operation, using the first image and the feature information, to generate the image corresponding to the first portion or the second portion of the first image. According to an embodiment, the instructions, when executed by the at least one processor collectively or individually, may cause the electronic device to generate, based on the painting operation, a third image that includes the first image and the image corresponding to the first portion or the second portion.

According to an embodiment, the instructions, when executed by the at least one processor collectively or individually, may cause the electronic device to obtain, from the feature information, a first text for generating the image corresponding to the first portion or the second portion of the first image using the first AI model stored in the memory.

According to an embodiment, the instructions, when executed by the at least one processor collectively or individually, may cause the electronic device to, based on the first text, generate a text prompt for generating the image corresponding to the first portion or the second portion of the first image, based on the first text.

According to an embodiment, the instructions, when executed by the at least one processor collectively or individually, may cause the electronic device to generates the third image by providing the text prompt, the feature information, and the first image to the second AI model 202 stored in the memory.

According to an embodiment, when the instructions are executed collectively or individually by the at least one processor, the electronic device may perform an in-painting operation to generate the image corresponding to the first portion of the first image using the second AI model.

According to an embodiment, the instructions, when executed by the at least one processor collectively or individually, may cause the electronic device to perform an out-painting operation to generate the image corresponding to the second portion of the first image using the second AI model.

According to an embodiment, the feature information may include information about a color, a shape, a form, an object, a background, or a composition of the second image.

According to an embodiment, the instructions, when executed by the at least one processor collectively or individually, may cause the electronic device to determine at least one image includes a person, an animal, an object, a background, or a place of the first image among a plurality within the capture threshold of images stored in the memory, as the second image.

According to an embodiment, the instructions, when executed by the at least one processor collectively or individually, may cause the electronic device to determine at least one image obtained within the capture threshold of the acquisition time of the first image among the plurality of images stored in the memory, as the second image.

According to an embodiment, the instructions, when executed by the at least one processor collectively or individually, may cause the electronic device to determine, as the second image, at least one image that includes a same person as a person of the first image among images obtained on the same day as a day on which the first image is obtained.

According to an embodiment, an operation method of the electronic device 201 may include, in response to a first command to edit a first image stored in the electronic device, an operation of identifying a second image captured within a capture threshold of an acquisition time of the first image stored in the electronic device or is related to a subject of the first image. According to an embodiment, the operation method of the electronic device may include an operation of obtaining, from the second image, feature information for generating an image corresponding to a first portion deleted inside the first image or a second portion to be expanded outside the first image. According to an embodiment, the operation method of the electronic device may include an operation of performing a painting operation to generate the image corresponding to the first portion or the second portion of the first image, using the first image and the feature information. According to an embodiment, the operation method of the electronic device may include an operation of generating a third image that includes the first image and the image corresponding to the first portion or the second portion generated based on the painting operation.

According to an embodiment, the operation method of the electronic device may include an operation of obtaining a first text for generating the image corresponding to the first portion or the second portion of the first image from the feature information by using the first AI model stored in the electronic device.

According to an embodiment, the operation method of the electronic device may further include an operation of generating, based on the first text, a text prompt for generating the image corresponding to the first portion or the second portion of the first image.

According to an embodiment, the operation of generating the third image may include an operation of generating the third image by providing the text prompt, the feature information, and the first image into the second AI model stored in the electronic device.

According to an embodiment, the operation of performing the painting operation may include an operation of performing an in-painting operation to generate the image corresponding to the first portion of the first image by using the second AI model.

According to an embodiment, the operation of performing the painting operation may include an operation of performing an out-painting operation to generate the image corresponding to the second portion of the first image using the second AI model.

According to an embodiment, the feature information may include information associated with at least one of a color, a shape, a form, an object, a background, or a composition of the at least one second image.

According to an embodiment, the operation method of the electronic device may further include an operation of determining at least one image that includes a person, an animal, an object, a background, or a place, of the first image, among a plurality of images stored in the electronic device, as the second image.

According to an embodiment, the operation method of the electronic device may further include an operation of determining at least one image obtained within the capture threshold of the acquisition time of the first image among the plurality of images stored in the electronic device, as the second image.

According to an embodiment, a non-transitory computer-readable recording medium may store instructions. According to an embodiment, the instructions, when executed by the at least one processor collectively or individually, may cause the electronic device to, in response to a first command to edit a first image stored in the electronic device, identify a second image captured within a capture threshold of an acquisition time of the first image stored in the electronic device or is related to a subject that includes in the first image. According to an embodiment, the instructions, when executed by the at least one processor collectively or individually, may cause the electronic device to obtain, from the at least one second image, feature information for generating an image corresponding to a first portion deleted inside the first image or a second portion to be expanded outside the first image. According to an embodiment, the instructions, when executed by the at least one processor collectively or individually, may cause the electronic device to perform a painting operation to generate the image corresponding to the first portion or the second portion of the first image, using the first image and the feature information. According to an embodiment, the instructions, when executed by the at least one processor collectively or individually, may cause the electronic device to generate a third image including the first image and the image corresponding to the first portion or the second portion generated based on the painting operation.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1440) including one or more instructions that are stored in a storage medium (e.g., internal memory 1436 or external memory 1438) that is readable by a machine (e.g., the electronic device 1401). For example, a processor (e.g., the processor 1420) of the machine (e.g., the electronic device 1401) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™M), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added. What is claims is:

1. An electronic device comprising:
at least one processor; and
memory storing instructions, wherein the instructions, when executed by the at least one processor individually or collectively, cause the electronic device to:
in response to a first command to edit a first image stored in the memory, identify a second image that is captured within a capture threshold of an acquisition time of the first image stored in the memory or is related to a subject of the first image;
obtain, from the second image, feature information for generating an image corresponding to a first portion deleted inside the first image or a second portion to be extended outside the first image;
perform, using the first image and the feature information, a painting operation to generate the image corresponding to the first portion or the second portion of the first image; and
generate, based on the painting operation, a third image comprising the first image and the image corresponding to the first portion or the second portion.

2. The electronic device of claim 1, wherein the instructions, when executed by the at least one processor individually or collectively, cause the electronic device to:
obtain, from the feature information, a first text for generating the image corresponding to the first portion or the second portion of the first image using a first AI model stored in the memory.

3. The electronic device of claim 2 wherein the instructions, when executed by the at least one processor individually or collectively, cause the electronic device to:
generate a text prompt for generating the image corresponding to the first portion or the second portion of the first image, based on the first text.

4. The electronic device of claim 3, wherein the instructions, when executed by the at least one processor individually or collectively, cause the electronic device to:
generate the third image by providing the text prompt, the feature information, and the first image into a second AI model stored in the memory.

5. The electronic device of claim 4, wherein the instructions, when executed by the at least one processor individually or collectively, cause the electronic device to:
perform an in-painting operation to generate the image corresponding to the first portion of the first image using the second AI model.

6. The electronic device of claim 4, wherein the instructions, when executed by the at least one processor individually or collectively, cause the electronic device to:
perform an out-painting operation to generate the image corresponding to the second portion of the first image using the second AI model.

7. The electronic device of claim 1, wherein the feature information comprises information of a color, a shape, a form, an object, a background, or a composition of the second image.

8. The electronic device of claim 1, wherein the instructions, when executed by the at least one processor individually or collectively, cause the electronic device to:
determine at least one image comprising a person, an animal, an object, a background, or a place of the first image among a plurality of images stored in the memory, as the second image.

9. The electronic device of claim 1, wherein the instructions, when executed by the at least one processor individually or collectively, cause the electronic device to:
determine at least one image obtained within the capture threshold of the acquisition time of the first image among a plurality of images stored in the memory, as the second image.

10. The electronic device of claim 1, wherein the instructions, when executed by the at least one processor individually or collectively, cause the electronic device to:
determine, as the second image, at least one image comprising a same person as a person of the first image among images obtained on a same day as a day the first image was obtained.

11. An operation method of an electronic device, the operation method comprising:
in response to a first command to edit a first image stored in the electronic device, identifying a second image captured within a capture threshold of an acquisition time of the first image stored in the electronic device or is related to a subject of the first image;
obtaining, from the second image, feature information for generating an image corresponding to a first portion deleted from the first image inside the first image or a second portion to be expanded from the first image outside the first image;
performing, using the first image and the feature information, a painting operation to generate the image corresponding to the first portion or the second portion of the first image; and
generating, based on the painting operation, a third image comprising the first image and the image corresponding to the first portion or the second portion.

12. The operation method of claim 11, further comprising:
obtaining, from the feature information using a first AI model stored in the electronic device, a first text for generating the image corresponding to the first portion or the second portion of the first image.

13. The operation method of claim 12, further comprising:
generating, based on the first text, a text prompt for generating the image corresponding to the first portion or the second portion of the first image.

14. The operation method of claim 13, wherein generating the third image further comprises:
generating the third image by providing the text prompt, the feature information, and the first image to a second AI model stored in the electronic device.

15. The operation method of claim 14, wherein performing the painting operation further comprises:
performing, using the second AI model, an in-painting operation to generate the image corresponding to the first portion of the first image.

16. A computer program product comprising a non-transitory computer-readable recording medium storing instructions configured to be executed by at least one processor of an electronic device to perform a plurality of operations comprising:
in response to a first command to edit a first image stored in the electronic device, identifying a second image captured within a capture threshold of an acquisition time of the first image stored in the electronic device or is related to a subject of the first image;
obtaining, from the second image, feature information for generating an image corresponding to a first portion deleted from the first image inside the first image or a second portion to be expanded from the first image outside the first image;
performing, using the first image and the feature information, a painting operation to generate the image corresponding to the first portion or the second portion of the first image; and
generating, based on the painting operation, a third image comprising the first image and the image corresponding to the first portion or the second portion.

17. The computer program product of claim 16, further comprising:
obtaining, from the feature information using a first AI model stored in the electronic device, a first text for generating the image corresponding to the first portion or the second portion of the first image.

18. The computer program product of claim 17, further comprising:
generating, based on the first text, a text prompt for generating the image corresponding to the first portion or the second portion of the first image.

19. The computer program product of claim 18, wherein generating the third image further comprises:
generating the third image by providing the text prompt, the feature information, and the first image to a second AI model stored in the electronic device.

20. The computer program product of claim 19, wherein performing the painting operation further comprises:
performing, using the second AI model, an in-painting operation to generate the image corresponding to the first portion of the first image.
